(19) United States
(12) Patent Application Publication
(10) Pub. No.: US 2015/0234066 A1
(43) Pub. Date: Aug. 20, 2015

(54) METHOD AND DEVICE FOR DE-BLENDING SEISMIC DATA USING SOURCE SIGNATURE

(71) Applicant: CGG SERVICES SA, Massy (FR)

(72) Inventors: Gordon Poole, East Grinstead (GB); Margherita Maraschini, Swanley (GB); Risto Siliqi, Paris (FR)

(21) Appl. No.: 14/429,562

(22) PCT Filed: Jul. 3, 2014
(86) PCT No.: PCT/EP2014/064257

§ 371 Date: Mar. 19, 2015

Related U.S. Application Data
(60) Provisional application No. 61/843,024, filed on Jul. 4, 2013.

(51) Int. Cl. G01V 1/28

(52) U.S. Cl. CPC G01V 1/28

(57) ABSTRACT

Methods and devices for seismic data processing de-blend seismic data using the different source signatures as discriminating factors. The methods may be used when sources were fired with dithering times.

### CROSS REFERENCE TO RELATED APPLICATIONS

This application claims priority and benefit from U.S. Provisional Patent Application No. 61/843,024, filed Jul. 4, 2013, for “De-blending for Simultaneous Source Acquisition Using Source Signature,” the content of which is incorporated in its entirety herein by reference.

### BACKGROUND

1. Technical Field

Embodiments of the subject matter disclosed herein generally relate to methods and devices used for processing blended seismic data. Blended seismic data is acquired when seismic receivers detect overlapping signals corresponding to seismic waves originating from different seismic sources.

2. Discussion of the Background

Seismic surveys are exploration methods that gather and record data related to seismic wave reflections from interfaces between geological layers of an explored subsurface structure. Seismic surveys are used in the oil and gas industry to search for and evaluate subterranean hydrocarbon deposits.

After a seismic source is activated to inject a seismic wave into an explored underground structure, seismic receivers detect energy (a signal) reflected from the explored underground structure to acquire and record seismic data for a recording period. The interval between sources' activation limits the seismic data acquisition rate. If seismic sources are activated so their respective recording periods overlap, acquired seismic data is blended and includes overlapping signals caused by one or more individual sources, cross-talk interference and noise. However, acquiring data with overlapping recording times reduces a survey's total acquisition time and cost. Instead of reducing acquisition time, acquiring data with overlapping recording times may be used to acquire a higher density dataset in the same survey time. Using blended data requires additional processing to extract seismic datasets focusing on individual signals.

Thus, in conventional surveying techniques, sources are activated so that a signal corresponding to one source does not overlap another signal corresponding to another source in their significant portions (i.e., when the ratio of the signals' amplitudes is substantially larger than each of the individual signal-to-noise ratios). When a source is activated, it is said that a “shot” has occurred. FIG. 1A illustrates seismic waves generated at different spatial positions 10, 12 and 14, at intervals so the recorded wavelets 10a-c corresponding to the seismic wave generated at spatial position 10 do not interfere (in time) with wavelets 12a-c corresponding to the seismic wave generated at spatial position 12. Wavelets correspond to reflections of a seismic wave injected into an explored underground structure, from interfaces in the explored structure between layers having different seismic wave propagation speeds. The wavelets created by one seismic wave form a signal in response to that wave. Recording at the receiver can be continuous in time (i.e., 16 in FIG. 1A) or separated to form regular seismic traces for each individual shot (i.e., signals in response to the seismic wave generated when the shot is fired), as shown in FIG. 1B. The traces illustrated in FIG. 1B form a receiver gather 20 (first wavelets, which correspond to reflections from a first interface forming curve a, second wavelets forming curve b, etc.).

FIG. 2A illustrates seismic waves generated at the same positions as in FIG. 1A, but at shorter intervals so the corresponding recording times partially overlap. Therefore, for example, wavelet 10c might be superimposed (in time) on wavelet 12a. FIG. 2B shows receiver gather 30 formed with regular seismic traces from continuous recording based on each shot's start time. FIG. 2B data have been acquired in less time than FIG. 1B data, but cross-talk like 32 is observed as noise on traces which is in fact signal wavelets on another trace.

Thus, for gather 30 in FIG. 2B, it is necessary to separate (de-blend) the energy (wavelets) associated with each shot as a preprocessing step, and then to proceed with conventional seismic data processing.

Varying shot timing (known as “timing dither”), which is seismic source activation at varying intervals, yields an incoherency in cross-talk noise timing in all domains other than the shot domain. For example, FIG. 3 (corresponding to Hampson et al., “Acquisition using simultaneous sources”, Leading Edge, Vol. 27, No. 7, the entire content of which is incorporated herein by reference) is a sequence of graphs representing the same blended seismic data in different domains: common shot, common receiver, common midpoint, and common offset.

Traditionally, data sets focusing on an individual signal are extracted from blended data using methods that fall into the following three categories (all relying to some degree on randomized timing):

1. Impulsive de-noising,

2. Iterative coherency enhancement/de-noising, and

3. Full modeling of energy from all sources.

Impulsive de-noising technique (disclosed, for example, by Stefani et al., “Acquisition using simultaneous sources,”69th EAGE Conference & Exhibition, 2007, the entire content of which is incorporated herein by reference) uses the fact that when data is sorted into any domain other than the common shot, the cross-talk noise from other sources is incoherent as illustrated in FIG. 3 (corresponding to the previously referred article of Hampson et al.). Note that in the common shot domain, cross-talk noise 40 is continuous. The variable firing times allow the use of impulsive-noise attenuation techniques that are already available and used in other processing steps, such as swell-noise attenuation. While this method can effectively remove the strongest cross-talk energy, low-amplitude cross-talk noise is not seen as impulsive and will not be removed.

Iterative coherency enhancement/de-noising techniques (described, for example, in Abma et al., “Separating simultaneous sources by inversion,”71st EAGE Conference & Exhibition, 2009, M. Maraschini et al., “Source Separation by Iterative Rank Reduction—Theory and Applications,”74^{th} EAGE Conference & Exhibition, 2012, and M. Maraschini et al., “An iterative SVD method for deblending: theory and examples,” SEG Technical Program Expanded Abstracts 2012, the entire contents of which are incorporated herein by reference) rely on the fact that cross-talk noise on some traces is a duplication of signal on other traces. This means that with the knowledge of the timing of all shots, a signal estimate made for one source can then be used to reduce the level of cross-talk for all other sources.

The full modeling of energy from all sources technique (described, for example, in Akerberg et al., “Simultaneous source separation by sparse Radon transform,”78th Ann. Internat. Mtg.: Soc. of Expl. Geophys, 2008, and Moore et al., “Simultaneous source separation using dithered sources,”78th Ann. Internat. Mtg.: Soc. of Expl. Geophys, 2008, the entire contents of which are incorporated herein by reference) has similarities to the iterative de-noising method, except that this formulation solves the relationship between source energy and cross-talk noise implicitly at the core of the problem formulation. Equations can be formulated as designing a transform domain for each source or spatial area (e.g., tau-p domain, Fourier domain, etc.) such that when it is reverse-transformed and re-blended, the raw input data is reconstructed as accurately as possible in a least squares sense.

This technique (i.e., full modeling of energy from all sources) uses the timings and positioning of all sources and also relies on a sparse solution to the equations. Once the transform domains have been calculated, the final step to de-blend the data requires application of reverse-transform without re-blending. While this method may result in some filtering of the original data, it removes low-amplitude cross-talk noise and preserves the primary signal. This method could be considered an alternative way to solve the same problem as the iterative coherency enhancement/de-noising technique (analogous to sparse least squares Radon versus inversion through “iterative cleaning”).

It is desirable to improve conventional methods of de-blending seismic data acquired with overlapping recording time while overcoming their drawbacks.

### SUMMARY

De-blending methods use different seismic source signatures as discriminating factors when extracting datasets corresponding to each of the overlapping signals from blended seismic data. Applying de-convolution with a target seismic source signature to the blended seismic data emphasizes a target signal among the overlapping signals, having an effect similar to a monochromatic focusing lens.

According to one embodiment, there is a method for de-blending seismic data recorded while simultaneously detecting a first signal from an explored underground structure caused by a first seismic wave characterized by a first source signature, and a second signal from the explored underground structure caused by a second seismic wave characterized by a second source signature, respectively, the second source signature being different from the first source signature. The method includes applying a designature operator corresponding to the first source signature, to first seismic data, which is extracted from the seismic data. The method further includes obtaining an estimate of seismic data related to the first signal, from the first seismic data to which the designature operator corresponding to the first source signature has been applied. The method then includes applying a source convolution based on the first source signature, to the estimate of seismic data related to the first signal, to obtain a refined estimate of the first seismic data, and extracting second seismic data from the seismic data by filtering out cross-talk contamination due to the first signal using the refined estimate of the first seismic data. The method the includes storing at least one of the second seismic data and the refined estimate of the first seismic data.

According to another embodiment, there is a seismic data processing apparatus including an input-output (I/O) interface and a data processing unit. The input-output (I/O) interface is configured to receive blended seismic data recorded while simultaneously detecting a first signal from an explored underground structure caused by a first seismic wave characterized by a first source signature, and a second signal from the explored underground structure caused by a second seismic wave characterized by a second source signature, which is different from the first source signature. The data processing unit is configured to apply a designature operator corresponding to the first source signature, to first seismic data, which is extracted from the seismic data, to obtain an estimate of seismic data related to the first signal, from the first seismic data to which the designature operator corresponding to the first source signature has been applied, to apply a source convolution based on the first source signature, to the estimate of seismic data related to the first signal, to obtain a refined estimate of the first seismic data, and to extract second seismic data from the seismic data by filtering out cross-talk contamination due to the first signal using the refined estimate of the first seismic data. At least one of the second seismic data and the refined estimate of the first seismic data are stored.

According to another embodiment, there is a method for exploring an underground structure. The method includes injecting a first seismic wave characterized by a first source signature into the explored underground structure, and injecting a second seismic wave characterized by a second source signature, which is different from the first seismic signature, into the explored underground structure. The method further includes recording blended seismic data while detecting simultaneously a first signal caused by the first seismic wave and a second signal cause by the second seismic wave emerging from the explored underground structure. The method then includes extracting at least first seismic data focusing on the first signal from the blended seismic data using a first source designature based on the first source signature to emphasize the first signal.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-B are graphical illustrations of seismic data without simultaneous acquisition;

FIGS. 2A-B are graphical illustrations of blended seismic data;

FIG. 3 is a graphical illustration of cross-talk in seismic data;

FIG. 4 is a flowchart of a method according to an embodiment;

FIG. 5A illustrates receiver recordings aligned according to the first source;

FIG. 5B illustrates receiver recordings aligned according to the second source;

FIG. 6 is a graphic illustration of an iterative de-blending method;

FIG. 7 is a graphic illustration of a method according to an embodiment;

FIG. 8 is a schematic diagram of a seismic data processing apparatus according to another embodiment;

FIG. 9 is a flowchart of a method for exploring a subsurface structure using seismic waves, according to another embodiment.

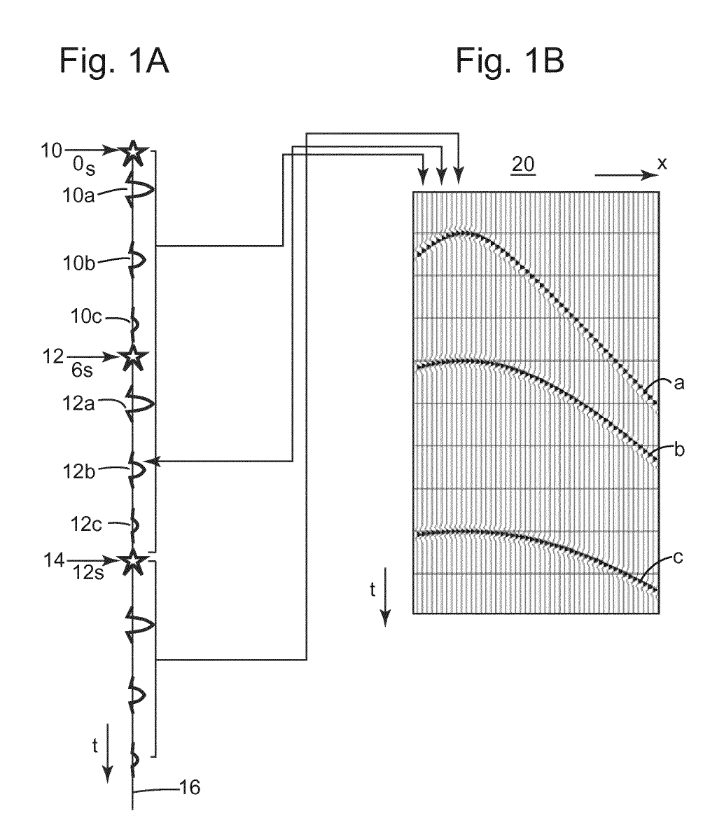

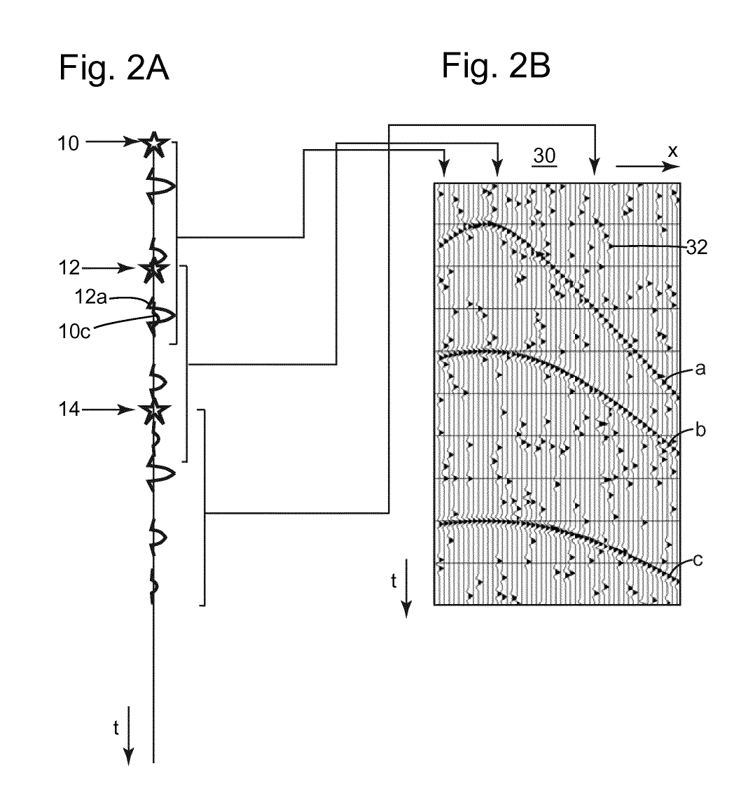

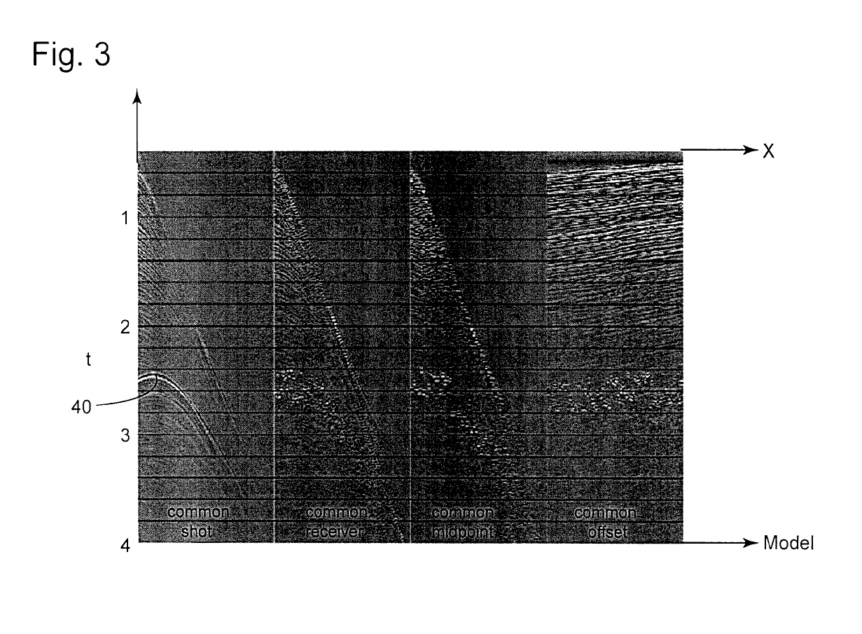

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed for blended seismic data acquired so that seismic receivers simultaneously record signals due to seismic waves successively injected into an explored underground structure. However, similar de-blending methods may also be used to analyze data sets related to electromagnetic waves or other data acquired in a similar manner.

Reference throughout the specification to “one embodiment” or “an embodiment” means that a particular feature, structure or characteristic described in connection with an embodiment is included in at least one embodiment of the subject matter disclosed. Thus, the appearance of phrases “in one embodiment” or “in an embodiment” in various places throughout the specification is not necessarily referring to the same embodiment. Further, the particular features, structures or characteristics may be combined in any suitable manner in one or more embodiments.

During seismic surveys, blended seismic data is acquired when a first seismic wave is injected into an underground structure, and then a second seismic wave is injected into the underground structure before seismic receivers have finished recording a signal caused by the first seismic wave. Although in the following description only one second seismic wave is discussed for simplicity and clarity, a person skilled in the art would understand that the second wave may be one of a plurality of second seismic waves. Blended seismic data have to be de-blended to be able to analyze the individual signals. The various de-blending methods described in this section use different source signatures characterizing the seismic waves causing the overlapping signals as discriminating factors. Conventional de-blending methods described in the “Discussion of the Background” section do not use seismic source signature information.

Generally, a seismic source signature is amplitude (e.g., pressure variation) versus time. The signal caused by a seismic wave characterized by a seismic source signature is a convolution of the explored underground structure's response and the seismic source signature. This signal is included in the amplitudes (e.g., pressure or displacement) detected in time by seismic receivers, which generate seismic data.

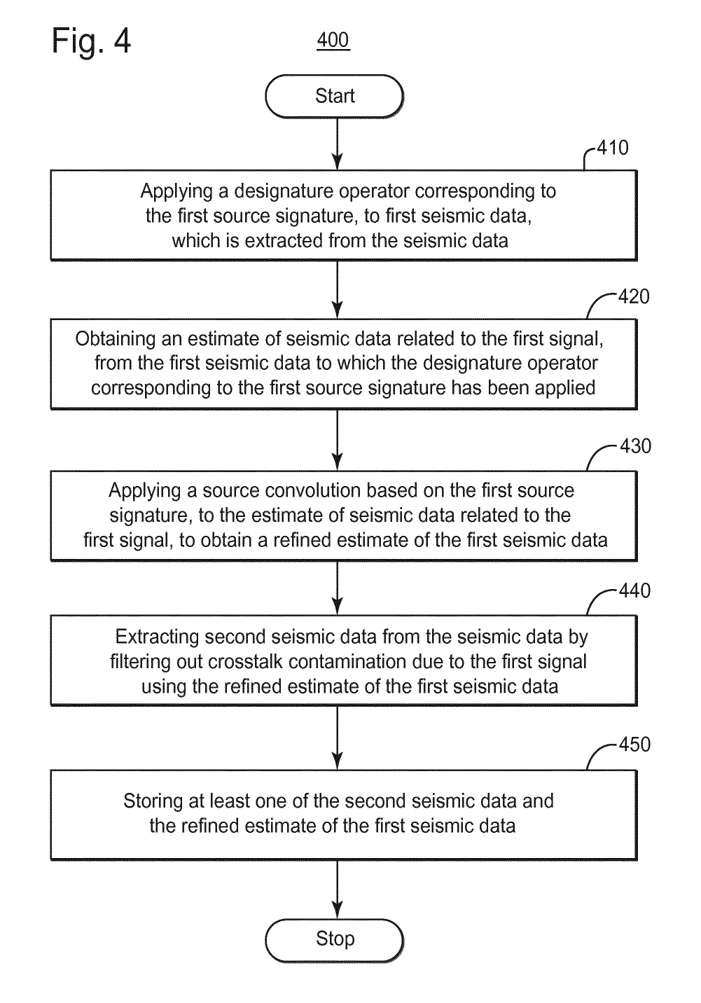

Blended seismic data may be acquired using land or marine data acquisition systems. FIG. 4 is a flowchart of a method 400 for de-blending seismic data recorded while simultaneously detecting a first signal caused by a first seismic wave characterized by a first source signature, and a second signal caused by a second seismic wave characterized by a second source signature different from the first source signature, according to an embodiment. Method 400 includes applying a designature operator corresponding to the first source signature, to first seismic data, which is extracted from the seismic data, at 410. This operation focuses energy related to the first seismic wave's reflections in the explored underground structure, while dispersing energy of a second seismic wave's reflections or other causes.

Method 400 further includes obtaining an estimate of seismic data related to the first signal, from the first seismic data to which the designature operator corresponding to the first source signature has been applied at 420. In this step, most of the second signal and the cross-talk are eliminated from the first seismic data to which the designature operator corresponding to the first source signature has been applied.

Method 400 further includes applying a source convolution based on the first source signature, to the estimate of seismic data related to the first signal, to obtain a refined estimate of the first seismic data, at 430. Then, at 440, second seismic data is extracted from the seismic data by filtering out cross-talk contamination due to the first signal using the refined estimate of the first seismic data. At 450, at least one of the second seismic data and the refined estimate of the first seismic data are stored.

A similar procedure may then be applied relative to the second seismic data usable to analyze the second signal. Thus, method 400 may further include:
applying a designature operator corresponding to the second source signature, to the second seismic data;
obtaining an estimate of seismic data related to the second signal, from the second seismic data to which the designature operator corresponding to the second source signature has been applied;
applying a source convolution based on the second source signature, to the estimate of seismic data related to the second signal, to obtain a refined estimate of the second data;
extracting the first seismic data from the seismic data by filtering out cross-talk contamination due to the second signal using the refined estimate of the second seismic data; and
storing at least one of the first seismic data and the refined estimate of the second seismic data.

Furthermore, the first seismic data and the second seismic data may be extracted iteratively until a predetermined condition is met. One example of predetermined condition is when a signal-to-noise ratio for the first signal or for the second signal in the refined estimate of the first seismic data or in the refined estimate of the second seismic data, respectively, to be less than a predetermined value. Another example of predetermined condition is performing a predetermined number of iterations.

Method 400 may also include outputting final first data and/or final second data. The final first data may be the refined first data resulting from the last iteration or the first seismic data extracted using the refined estimate of the second seismic data resulting from the last iteration. Similarly, the final second data may be the refined second seismic data resulting from the last iteration, or the second seismic data extracted using the refined estimate of the first seismic data resulting from the last iteration. The final first and/or second data may then be further processed to generate images of the explored underground structure.

The first and second seismic waves may be generated by different sources (i.e., a first seismic source and a second seismic source, respectively). Such sources are said to be simultaneously activated. However, first and second seismic waves may be generated by the same source (e.g., in the case of vibrators). In other words, “simultaneously-activated sources” means one or more sources are activated at an interval so that seismic data includes portions with overlapping signals, i.e., blended seismic data. The interval between injecting the first and second seismic waves into the explored underground structure may vary from shot to shot (i.e., successive seismic waves). For example, for a listening time of 6 s, a later shot (i.e., generating and injecting the second wave) may occur between 3 and 4 s after the first shot.

Depending on the type of data acquisition system and seismic sources used, different source signatures may be achieved by controlling different parameters. For example, in a marine survey, if two gun arrays, each including plural airguns (e.g. 48 airguns), are fired in a flip-flop mode, the source signatures depend on the overall arrangement and individual characteristics (e.g., the respective pneumatic chamber volumes) of the individual airguns. Additionally, for each gun array, the air guns are fired according to a vector of small delays (e.g., a few milliseconds or tens of milliseconds) from a generic firing time. Any change in this vector of small delays alters the gun array's signature.

Seismic vibrators are a type of seismic source used in both marine and land seismic surveys. As opposed to airgun arrays and dynamite, which are impulsive-type seismic sources (generating seismic waves lasting less than 1 s at one location), seismic vibrators generate seismic waves over an extended period (e.g., a few seconds or dozens of seconds). A vibrator source may consist of one or plural seismic vibrators. The vibrator's source signature may be characterized by a frequency versus time pattern (known as a sweep) while seismic waves are generated. Seismic data acquired using vibrators may be correlated with the sweep to convert the extended detected signal into an impulse-type response. Marine or land vibrators may use pseudo-random sweeps, random sweeps, optimal sweeps, regular (linear) sweeps, step sweeps, or each source may use a different type of sweep to obtain different source signatures.

Seismic waves may also be generated by hybrid sources. In a marine seismic survey, hybrid sources may include airguns and vibrators. In land surveys, hybrid sources may include a combination of vibrator trucks and dynamite.

Source signatures may be constant during the seismic survey, i.e., seismic waves generated by seismic source 1 are always characterized by source signature 1, seismic waves generated by seismic source 2 are always characterized by source signature 2, etc. However, the methods according to various embodiments may be applied when the source signatures vary at each activation:
a first seismic wave generated by seismic source 1 is characterized by source signature 1.1 at a first source activation, by source signature 1.2 at a second source activation, . . . , by source signature 1.N at an N-th source activation; and
a second seismic wave generated by seismic source 2 is characterized by source signature 2.1 at a first source activation, by source signature 2.2 at a second source activation, . . . , by source signature 2.N at an N-th source activation, etc.
the same method can be applied with only one source, with source signature varying with the source activation.

The manner of activating seismic sources may include an element of randomized source timing, partial randomized source timing, or optimal source timing (where activation times are designed to optimize separation with a given algorithm) to modify the source signature at each activation. Vibrating sources may be modified to each have a different sweep from one source activation to the next. Airgun arrays may fire the air guns in a synchronized, random, optimal or desynchronized fashion. The vibrator or desynchronized air-gun arrays may operate with energy being emitted continuously over a period of several minutes or hours.

Looking closer now at the manner of extracting the first and second data, impulsive noise attenuation methods (e.g., similar to the impulsive de-noising techniques mentioned in the Background section) may be used to filter the data represented in a common receiver domain, a common mid-point domain, or a common offset domain. This approach to extracting first data (and, similarly, second data) may be used whether or not at least one of the first and second source signatures are modified at each activation (e.g., with random delays for air-gun arrays), but it is even more efficient when the source signatures are modified. Also, this approach may be used with or without the dithering time. This approach can be modified to include blended acquisition generated by only one source, or to deblend seismic surveys that uses continuous recording acquisition.

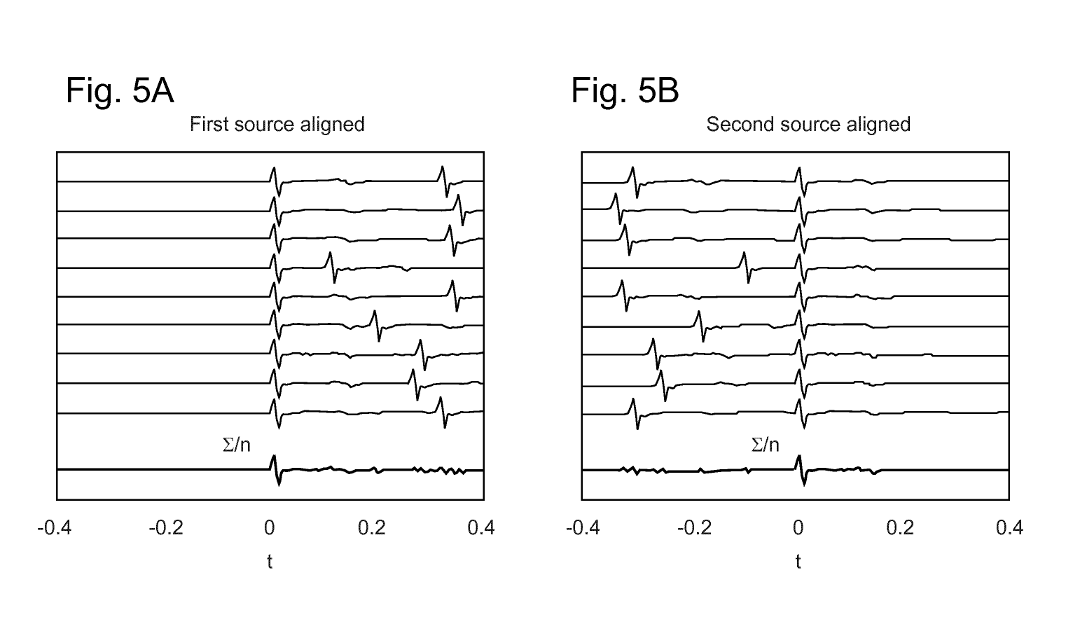

In another embodiment, de-blending is implemented within an iterative method based on dithering time. As a consequence of the dithering time, reflections related to each source response can be viewed as coherent in one time configuration and as random noise in a different time configuration. For example (as reproduced from the previously referred to article of Hampson et al.), FIG. 5A illustrates a time configuration in which timing corresponding to a first source is aligned, while timing corresponding to a second source is not, and FIG. 5B illustrates a time configuration in which timing corresponding to the second shot is aligned, while the timing corresponding to the first shot is not.

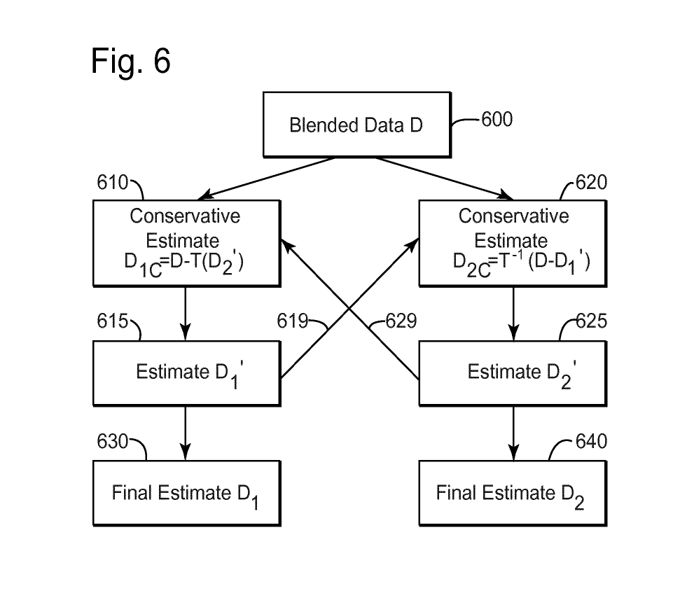

Considering two sources (although these methods can be applied to several simultaneous sources or to one source firing with short time intervals) and the activation time of the second source varying randomly with respect to the first source's activation time, the blended data (actually measured) is D=D₁+T(D₂), where D₁ represents signal in response to the first waves generated by the first source, and D₂ represents a theoretical response to the second waves (generated by the second source) without time delays. Operator T is a time-delay operator that shifts traces by the delay time of the second source. D is conceptually a data cuboid whose dimensions are t-x-y or time-offset-shot (e.g., may be a single source-cable combination from one sail-line of a marine survey). In any common offset slice of D, D₁ appears coherent, while T(D₂) is random because each trace belongs to a different shot, hence the imprint of the random delay sequence randomizes the second source component. In a different time representation in which the random delays are removed from D, data is T⁻¹ (D)=T⁻¹(D₁)+D₂; in this representation, the source 1 component now appears random in the common offset domain while the source 2 component becomes coherent. Operator T⁻¹ is a time-delay operator that shifts traces by the negative delay time of the second source, i.e. T⁻¹(T(D))=D. Exploiting this duality by continually switching between these two time configurations D and T⁻¹(D), first data and second data may be extracted from blended data D as illustrated in FIG. 6.

At each iteration, noise (e.g., due to cross-talk) is attenuated for conservative estimates of each signal (D_{1c} and D_{2c}) to obtain estimates of the first and second data (D′₁ and D′₂). The conservative estimates are obtained by subtracting from the blended data D time aligned estimate of the other source(s) data. Thus, the conservative estimate of the first data D_{1c}=D−T(D₂′) is obtained at 610, and the conservative estimate of the second data D_{2c}=T⁻¹(D−D₁′) is obtained at 620. Enhanced estimates of the first and second data (D₁′ and D₂′) are obtained at 615 and 625, respectively, using, for example, Cadzow filtering (applied to small time-offset-shot cubes of D), rank reduction filtering, filtering or thresholding in the curvelet domain, POCS (projection onto convex sets) algorithm (i.e., a method of iterative thresholding/filtering in the Fourier domain), FX de-convolution, projection filtering, dip filtering, x-t de-convolution, sparse radon in time or frequency domain, filtering using the anti-leakage Fourier transform, filtering using the tau-p version of the anti-leakage Fourier transform, etc. Thus, seismic data is represented in a time configuration aligned with the first seismic wave in 610, and 615 (as in FIG. 5A), while seismic data is represented in a time configuration aligned with the second seismic wave (as in FIG. 5B) in 620 and 625. The enhanced estimates of the first and second data (D′₁ and D′₂) obtained at 615 and 625 are used to evaluate the conservative estimates at the next iteration at 620 and 610, respectively, as suggested by arrows 629 and 619. The iterative process ends when a predetermined condition is met (e.g., a predetermined number of iterations, or a signal-to-removed-noise ratio becomes smaller than a predetermined threshold), to output final estimates of the first and second data at 630 and 640, respectively. The final estimates may be the refined estimates (D₁′ and D₂′) obtained at the last iteration or conservative estimates (D−T(D₂′) and T⁻¹(D−D₁′)) obtained using the refined estimates obtained at the last iteration.

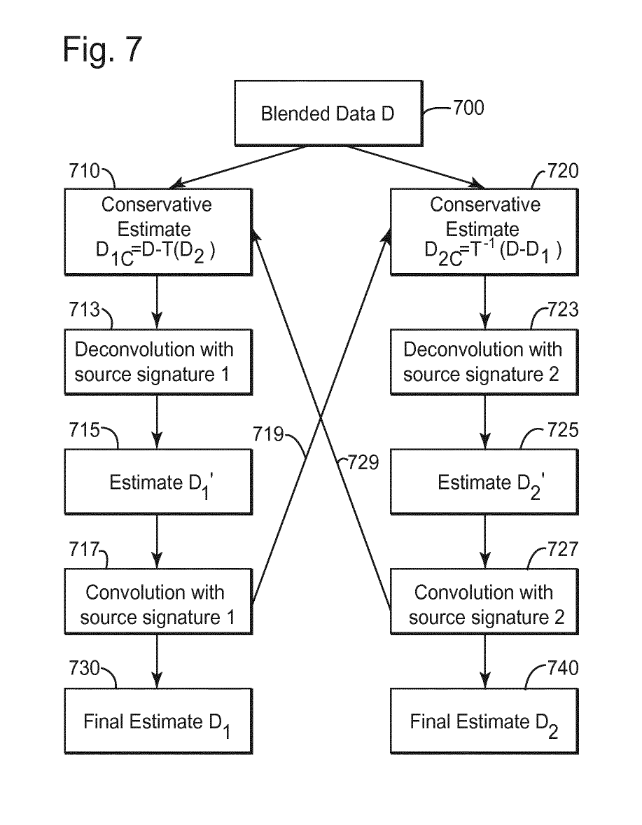

FIG. 7 illustrates implementation of extracting first and second seismic data from blended seismic data D (700) according to another embodiment. Steps 710 and 720 are similar to steps 610 and 620. Different from method 600, source designature operations 713 and 723 are performed (via a de-convolution with source signatures 1 and 2) before filtering at 715 and 725, respectively. The source designature operation using a source signature has the effect of focusing and strengthening the energy (first or second) sought to be isolated (i.e., related to the waves characterized by the respective source signature), while dispersing the energy from another (second or first) source. The source signatures are designed to be “as orthogonal as possible,” meaning that when a designature operator corresponding to a source signature is applied, the energy from the other source to become as diffused as possible. Then, at 715 and 725, estimates of the first seismic data, D₁′, and of the second seismic data, D₂′, are obtained by filtering in manners similar to 615 and 625. Source re-signature operations are then performed at 717 and 727, by applying a convolution with source signatures 1 and 2, respectively, to obtain refined estimates of the first and second data (D₁′ and D₂′). These refined estimates are used to evaluate the conservative estimates at the next iteration at 720 and 710, respectively, as suggested by arrows 729 and 719.

The iterative process ends when a predetermined condition is met (e.g., a predetermined number of iterations, or a signal-to-removed-noise ratio becomes smaller than a predetermined threshold), to output final estimates of the first and second data at 730 and 740, respectively. These final estimates of first and second seismic data may be the refined estimates (D₁′ and D₂′) obtained at the last iteration or the conservative estimates D−T(D₂′) and T⁻¹(D−D₁′) calculated using the refined estimates obtained at the last iteration. The designature and resignature operations may be single operators or vary with directivity. If they vary with directivity, the source designature and resignature operations may be applied in the FK or tau-p domain. The source designature step converts the energy emitted from a source to an impulsive wavelet (within the constraints of any energy deficiency of the original signal, e.g. in marine the free surface ghost). Source directivity relates to a source whose energy varies with angle and azimuth leaving the source. An example of directional source designature may be found in Poole et al, “Shot-to-shot directional designature using near-field hydrophone data,” in SEG 2013 conference proceedings. The designature and resignature operations may be designed so that when the designature and resignature operators are convolved, the result is a spike at zero lag.

The iterative loop processing illustrated in FIG. 7 is a feature, not a constraint. One can obtain individual seismic data (e.g., only one of the first seismic data and the second seismic data) by
(A) generating a conservative estimate of a signal corresponding to the seismic wave to which the individual seismic data corresponds;
(B) applying a de-convolution based on the source signature that characterizes the seismic wave, to the conservative estimate of the signal to evaluate a subsurface structure's response function;
(C) filtering the first subsurface structure's response function to emphasize the signal; and
(D) convolving the focused subsurface structure's response function with the source signature to generate a refined estimate of the signal.

In one embodiment, steps (A)-(D) above may be used to obtain one set of seismic data (e.g., first seismic data), while other methods may be used to obtain the other(s) individual seismic data (e.g., second seismic data usable to analyze the second signal(s)).

The use of different seismic source signatures as discriminating factors provides the advantage that, during each filtering, the events of interest are focused, while the cross-talk energy is defocused or spread, improving the efficiency of most filters. Using different seismic source signatures as discriminating factors may optionally be combined with time dithering. Time delays between sources may no longer be required, in particular, if the source signatures vary from shot to shot. Instead of applying time dithering as a separate process to designature/resignature, the shifts may instead be applied directly to the designature and resignature operators.

In another embodiment, de-blending is implemented within an iterative method based on dithering time without the need to specify the source that is activated in each position. This method allows 1, 2 or more sources to be considered. This strategy can also be applied to dataset obtained using continuous recording, and independent simultaneous shooting acquisition. The dataset is arranged in a 3D data cube, each trace generated by the source activation Si and recorded by the receiver Rj is placed in the mid-point position and is aligned in time according to the firing time of Si. As a consequence of the dithering time, reflections related to Si are coherent, and reflections related to the other source activations are incoherent.

The blended data (actually measured) is D=D₀+Q(D₀), where D₀ represents signal in response to the injected waves, and operator Q is an operator that allows calculating the crosstalk noise generated by the data D₀ based on the firing time of each source. D₀ is coherent, while Q(Do) is not. Several deblending strategies can be used to obtain D₀ from D. Similar to the previous described embodiment, at each iteration an estimate of D₀ can be obtained, and the corresponding cross-talk Q(D₀) calculated and subtracted from the input, the filter used to obtain D₀ becoming milder with iterations. In this embodiment, source signature varying with source activation can improve the deblending process.

In another embodiment, full modeling of energy from all sources (as described in the Background section) is used to extract first seismic data from the data emphasizing the first signal. This step also includes the source resignature operation as part of the reverse transform. The source resignature may be applied in the data domain or in the transform domain. The sparseness constraint works better if the seismic waves have different signatures, or if the signatures vary from shot to shot.

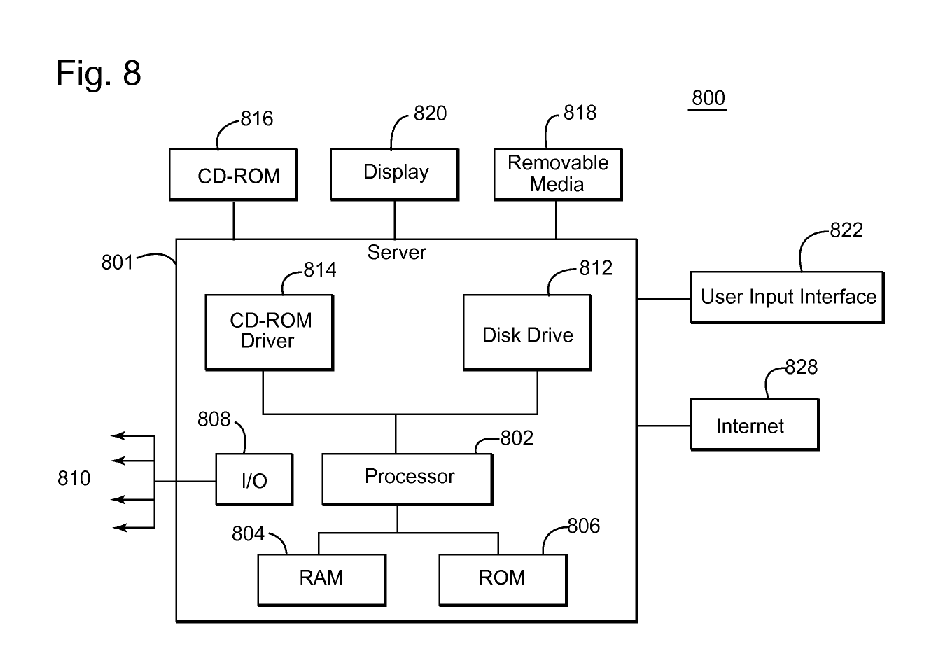

A schematic diagram of a seismic data processing apparatus 800 configured to perform the methods according to various above-discussed embodiments is illustrated in FIG. 8. Hardware, firmware, software or a combination thereof may be used to perform the various steps and operations. Apparatus 800 may include server 801 having a data processing unit (processor) 802 coupled to a random access memory (RAM) 804 and to a read-only memory (ROM) 806. ROM 806 may also be other types of storage media to store programs, such as programmable ROM (PROM), erasable PROM (EPROM), etc. Methods according to various embodiments described in this section may be implemented as computer programs (i.e., executable codes) non-transitorily stored on RAM 804 or ROM 806.

Processor 802 may communicate with other internal and external components through input/output (I/O) circuitry 808 and bussing 810. Input-output (I/O) interface (808) is configured to receive blended seismic data recorded while simultaneously detecting a first signal from an explored underground structure caused by a first seismic wave characterized by a first source signature, and a second signal from the explored underground structure caused by a second seismic wave characterized by a second source signature, which is different from the first source signature.

Processor 802 carries out a variety of functions as are known in the art, as dictated by software and/or firmware instructions. Processor 802 is configured to apply a designature operator corresponding to the first source signature, to first seismic data, which is extracted from the seismic data, thereby to obtain data emphasizing the first signal corresponding to the first seismic wave. Processor 802 is further configured to obtain an estimate of seismic data related to the first signal, from the first seismic data to which the designature operator corresponding to the first source signature has been applied. Processor 802 unit is further configured to apply a source convolution based on the first source signature, to the estimate of seismic data related to the first signal, to obtain a refined estimate of the first seismic data, and to extract second seismic data from the seismic data by filtering out cross-talk contamination due to the first signal using the refined estimate of the first seismic data.

Processor 802 may extract the second seismic data by filtering out cross-talk contamination due to the first signal, using an impulsive-noise attenuation method, in a common receiver domain, a common mid-point domain, or a common offset domain.

Processor 802 may be further configured:
to apply a designature operator corresponding to the second source signature, to the second seismic data
to obtain an estimate of seismic data related to the second signal, from the second seismic data to which the designature operator corresponding to the second source signature has been applied;
to apply a source convolution based on the second source signature, to the estimate of seismic data related to the second signal, to obtain a refined estimate of the second data; and
to extract the first seismic data from the seismic data by filtering out cross-talk contamination due to the second signal using the refined estimate of the second seismic data.

Processor 802 may be configured to iteratively extract the first seismic data and the second seismic data until a predetermined condition is met.

Server 801 may also include one or more data storage devices, including disk drives 812, CD-ROM drives 814, and other hardware capable of reading and/or storing information, such as a DVD, etc. The first seismic data, second seismic data, refined first data and/or refined second data may be stored in these data storage devices. In one embodiment, software for carrying out the above-discussed methods may be stored and distributed on a CD-ROM 816, removable media 818 or other forms of media capable of storing information. The storage media may be inserted into, and read by, devices such as the CD-ROM drive 814, disk drive 812, etc. Server 801 may be coupled to a display 820, which may be any type of known display or presentation screen, such as LCD, plasma displays, cathode ray tubes (CRT), etc. Server 801 may control display 820 to exhibit images of the explored subsurface structure generated using first and/or second seismic data. A user input interface 822 may include one or more user interface mechanisms such as a mouse, keyboard, microphone, touch pad, touch screen, voice-recognition system, etc.

Server 801 may be coupled to other computing devices, such as the equipment of a vessel, via a network. The server may be part of a larger network configuration as in a global area network such as the Internet 828, which allows ultimate connection to the various landline and/or mobile client/watcher devices.

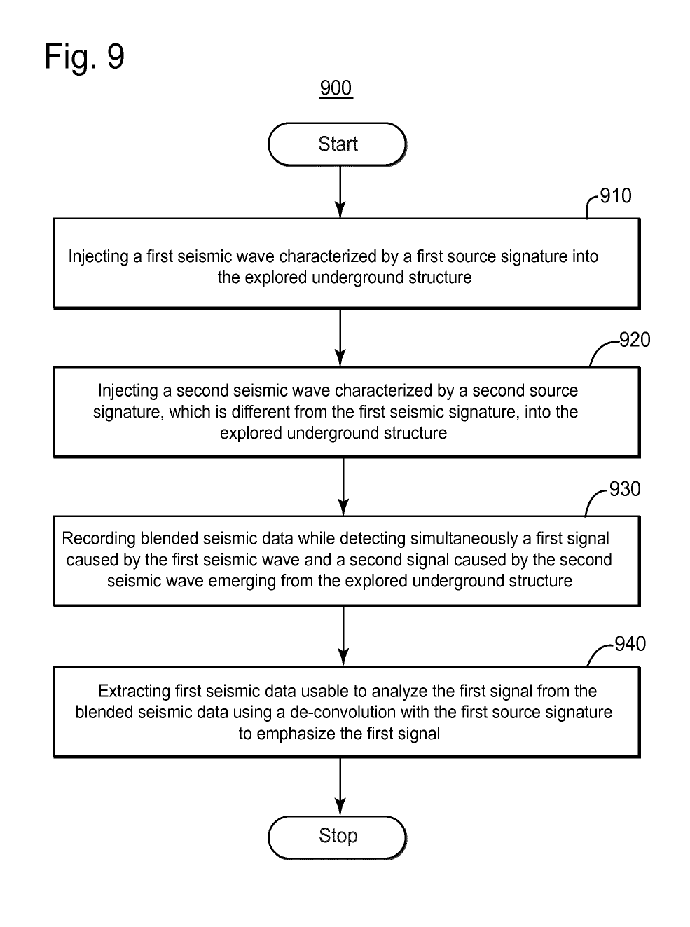

The above-described methods create the opportunity to acquire seismic data more efficiently (in shorter time or with higher density) without degrading the quality of the explored subsurface image. FIG. 9 is a flowchart of a method 900 for exploring an underground structure according to another embodiment. Method 900 includes injecting a first seismic wave characterized by a first source signature into the explored underground structure at 910, and injecting a second seismic wave characterized by a second source signature, which is different from the first seismic signature, into the explored underground structure at 920. All the above-discussed versions of different source signatures and time dithering may be applied.

Method 900 further includes recording blended seismic data while detecting simultaneously a first signal caused by the first seismic wave and a second signal cause by the second seismic wave emerging from the explored underground structure at 930. Method 900 then includes extracting at least first seismic data focusing on the first signal from the blended seismic data using a first source designature based on the first source signature to emphasize the first signal at 940. Step 940 is part of seismic data analysis, while Steps 910-930 are directed to seismic data acquisition.

The disclosed embodiments provide methods and devices that extract data sets usable to de-blend blended seismic data using the different seismic source signatures of seismic waves causing overlapping signals as discriminating factors. These de-blending methods may be used for seismic data acquired both in land and marine seismic surveys (including transition zone surveys). It should be understood that this description is not intended to limit the invention. On the contrary, the exemplary embodiments are intended to cover alternatives, modifications and equivalents, which are included in the spirit and scope of the invention as defined by the appended claims. Further, in the detailed description of exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in particular combinations, each feature or element may be usable alone without the other features and elements of the embodiments or in other various combinations with or without other features and elements disclosed herein.

The written description uses examples of the subject matter disclosed to enable any person skilled in the art to practice the same, including making and using the described devices or systems and performing any of the described methods. The patentable scope of the subject matter is defined by the claims, and may include other examples that occur to those skilled in the art. Such examples are intended to be within the scope of the claims.

1. A method for de-blending seismic data recorded while simultaneously detecting a first signal from an explored underground structure caused by a first seismic wave characterized by a first source signature, and a second signal from the explored underground structure caused by a second seismic wave characterized by a second source signature, respectively, the second source signature being different from the first source signature, the method comprising:
applying a designature operator corresponding to the first source signature, to first seismic data, which is extracted from the seismic data;
obtaining an estimate of seismic data related to the first signal, from the first seismic data to which the designature operator corresponding to the first source signature has been applied;
applying a source convolution based on the first source signature, to the estimate of seismic data related to the first signal, to obtain a refined estimate of the first seismic data;
extracting second seismic data from the seismic data by filtering out cross-talk contamination due to the first signal using the refined estimate of the first seismic data; and
storing at least one of the second seismic data and the refined estimate of the first seismic data.

2. The method of claim 1, further comprising:
applying a designature operator corresponding to the second source signature, to the second seismic data;
obtaining an estimate of seismic data related to the second signal, from the second seismic data to which the designature operator corresponding to the second source signature has been applied;
applying a source convolution based on the second source signature, to the estimate of seismic data related to the second signal, to obtain a refined estimate of the second data;
extracting the first seismic data from the seismic data by filtering out cross-talk contamination due to the second signal using the refined estimate of the second seismic data; and
storing at least one of the first seismic data and the refined estimate of the second seismic data.

3. The method of claim 2, wherein
the first seismic data and the second seismic data are extracted iteratively until a predetermined condition is met.

4. The method of claim 3, wherein the predetermined condition is an evaluated signal-to-noise ratio for the first signal or for the second signal in the refined estimate of the first seismic data or in the refined estimate of the second seismic data, respectively, to be less than a predetermined value.

5. The method of claim 3, wherein the predetermined condition is performing a predetermined number of iterations.

6. The method of claim 1, wherein an interval between injecting the first seismic wave in the explored underground structure and injecting the at least one second seismic wave in the explored underground structure varies during a sequence of shots.

7. The method of claim 1, wherein at least one of the first source signature and the at least one second source signature varies during a sequence of shots.

8. The method of claim 1, where the seismic data has been acquired using continuous recording.

9. The method of claim 1, where the first seismic wave and the second seismic wave are generated independently from one another.

10. The method of claim 1, wherein at least one of the first seismic wave and the second seismic wave is generated by a seismic source including plural individual seismic source elements activated random, partially-random or optimized to favor extracting the first seismic data.

11. The method of claim 10, wherein the plural individual seismic sources include one or more sources having a first type and one or more sources having a second type.

12. The method of claim 10, wherein the plural individual seismic sources include air guns fired according to an activation sequence, which varies from shot to shot.

13. The method of claim 10, wherein the plural individual seismic sources include plural vibrators using one or more of pseudo-random sweeps, random sweeps, optimal sweeps, linear sweeps, step sweeps or at least two vibrators have different sweeps.

14. The method of claim 1, wherein the second seismic data is extracted using an impulsive method in a common receiver domain, a common mid-point domain, or a common offset domain.

15. The method of claim 1, wherein the extracting of the first seismic data comprises:
modeling energy for the first seismic wave and the second seismic wave to design a transform domain corresponding to each of the first seismic wave and the second seismic wave taking into account the first signature and the second signature, respectively.

16. A seismic data processing apparatus, comprising:
an input-output (I/O) interface configured to receive blended seismic data recorded while simultaneously detecting a first signal from an explored underground structure caused by a first seismic wave characterized by a first source signature, and a second signal from the explored underground structure caused by a second seismic wave characterized by a second source signature, which is different from the first source signature; and
a data processing unit configured
to apply a designature operator corresponding to the first source signature, to first seismic data, which is extracted from the seismic data,
to obtain an estimate of seismic data related to the first signal, from the first seismic data to which the designature operator corresponding to the first source signature has been applied,
to apply a source convolution based on the first source signature, to the estimate of seismic data related to the first signal, to obtain a refined estimate of the first seismic data, and
to extract second seismic data from the seismic data by filtering out cross-talk contamination due to the first signal using the refined estimate of the first seismic data,
wherein at least one of the second seismic data and the refined estimate of the first seismic data are stored.

17. The apparatus of claim 16, wherein the data processing unit is further configured
to apply a designature operator corresponding to the second source signature, to the second seismic data;
to obtain an estimate of seismic data related to the second signal, from the second seismic data to which the designature operator corresponding to the second source signature has been applied;
to apply a source convolution based on the second source signature, to the estimate of seismic data related to the second signal, to obtain a refined estimate of the second data; and
to extract the first seismic data from the seismic data by filtering out cross-talk contamination due to the second signal using the refined estimate of the second seismic data,
wherein at least one of the first seismic data and the refined estimate of the second seismic data are stored.

18. The apparatus of claim 17, wherein the data processing unit is further configured to iteratively extract the first seismic data and the second seismic data until a predetermined condition is met.

19. The apparatus of claim 17, further comprising:
a memory configured to store the first seismic data, the second seismic data, and the refined estimate of the first seismic data and/or the refined estimate of the second seismic data.

20. A method for exploring an underground structure, the method comprising:
injecting a first seismic wave characterized by a first source signature into the explored underground structure;
injecting a second seismic wave characterized by a second source signature, which is different from the first seismic signature, into the explored underground structure;
recording blended seismic data while detecting simultaneously a first signal caused by the first seismic wave and a second signal cause by the second seismic wave emerging from the explored underground structure; and
extracting at least first seismic data focusing on the first signal from the blended seismic data using a first source designature based on the first source signature to emphasize the first signal.
